(19) United States
(12) Patent Application Publication
(10) Pub. No.: US 2026/0029651 A1
(43) Pub. Date: Jan. 29, 2026

(54) METHOD AND SYSTEM FOR PERFORMING SPATIAL FOVEATION BASED ON EYE GAZE

(71) Applicant: Magic Leap, Inc., Plantation, FL (US)

(72) Inventor: Edward Diaz, Hialeah, FL (US)

(73) Assignee: Magic Leap, Inc., Plantation, FL (US)

(21) Appl. No.: 19/345,822

(22) Filed: Sep. 30, 2025

Related U.S. Application Data
(63) Continuation of application No. PCT/US2024/025044, filed on Apr. 17, 2024.
(60) Provisional application No. 63/461,120, filed on Apr. 21, 2023.

(51) Int. Cl. G02B 27/01; G02B 27/00; G06F 3/01; G06T 5/80; G06T 19/00

(52) U.S. Cl. CPC G02B 27/0172; G02B 27/0093; G06F 3/012; G06F 3/013; G06T 5/80; G06T 19/006

(57) ABSTRACT

A method includes determining an eye gaze location of a user and generating a spatial foveation map based on the eye gaze location. The method also includes receiving an image, forming a spatially foveated image using the image and the spatial foveation map, and transmitting the spatially foveated image to a wearable device. The method further includes spatially defoveating the spatially foveated image to produce a spatially defoveated image and displaying the spatially defoveated image.

### CROSS-REFERENCES TO RELATED APPLICATIONS

This application is a continuation of International Patent Application No. PCT/US2024/025044, filed Apr. 17, 2024, entitled “METHOD AND SYSTEM FOR PERFORMING SPATIAL FOVEATION BASED ON EYE GAZE,” which claims the benefit of and priority to U.S. Provisional Patent Application No. 63/461,120, filed Apr. 21, 2023, entitled “METHOD AND SYSTEM FOR PERFORMING SPATIAL FOVEATION BASED ON EYE GAZE,” the entire disclosures of which are hereby incorporated by reference, for all purposes, as if fully set forth herein.

### BACKGROUND OF THE INVENTION

Modern computing and display technologies have facilitated the development of systems for so called “virtual reality” or “augmented reality” experiences, wherein digitally reproduced images or portions thereof are presented to a viewer in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the viewer.

Referring to FIG. 1, an augmented reality scene 100 is depicted. The user of an AR technology sees a real-world park-like setting 106 featuring people, trees, buildings in the background, and a real-world concrete platform 120. The user also perceives that he/she “sees” “virtual content” such as a robot statue 110 standing upon the real-world concrete platform 120, and a flying cartoon-like avatar character 102 which seems to be a personification of a bumble bee. The robot statue 110 and the flying cartoon-like avatar character 102 are “virtual” in that they do not exist in the real world. Because the human visual perception system is complex, it is challenging to produce AR technology that facilitates a comfortable, natural-feeling, rich presentation of virtual image elements amongst other virtual or real-world imagery elements.

Despite the progress made in these display technologies, there is a need in the art for improved methods and systems related to augmented reality systems, particularly, display systems.

### SUMMARY OF THE INVENTION

The present invention relates generally to methods and systems related to projection display systems including wearable displays. More particularly, embodiments of the present invention provide methods and systems useful for virtual content compression and storage. Merely by way of example, a warp reprojection engine utilized for head pose correction prior to display of the virtual content also implements spatial defoveation in order conserve system resources. The invention is applicable to a variety of applications in computer vision and image display systems.

Numerous benefits are achieved by way of the present invention over conventional techniques. For example, embodiments of the present invention provide methods and systems that reduce memory and processing load. By knowing where the human gaze is currently located and taking the human gaze into account, embodiments of the present invention can reduce the quality (i.e., the bandwidth) at locations in an image where the user is not looking, i.e., locations in the image that are spatially separated from the eye gaze location, thereby decreasing the image quality in these regions and decreasing the overall need to send something at a superior quality setting that the human eye would not be able to discern, because the human eye is not currently focused on these non-gaze locations. Thus, embodiments of the present invention provide a video compression algorithm that takes human gaze into account and utilizes a foveated compression algorithm dependent on human gaze. Subsequently, prior to display to the user, the spatially foveated image is defoveated using a warp reprojection processor that also warps the image to be displayed based on the head pose of the wearable device. These and other embodiments of the invention along with many of its advantages and features are described in more detail in conjunction with the text below and attached figures.

### BRIEF DESCRIPTION OF THE DRAWINGS

FIG. 1 illustrates a user's view of augmented reality (AR) through an AR device.

FIG. 2A illustrates a cross-sectional, side view of an example of a set of stacked waveguides that each includes an incoupling optical element.

FIG. 2B illustrates a perspective view of an example of the one or more stacked waveguides of FIG. 2A.

FIG. 2C illustrates a top-down, plan view of an example of the one or more stacked waveguides of FIGS. 2A and 2B.

FIG. 3 is a simplified illustration of an eyepiece waveguide having a combined pupil expander according to an embodiment of the present invention.

FIG. 4 illustrates an example of wearable display system according to an embodiment of the present invention.

FIG. 5 shows a perspective view of a wearable device according to an embodiment of the present invention.

FIG. 6A is an example of an original N×M image.

FIG. 6B is a spatially foveated n×m image according to an embodiment of the present invention.

FIG. 7 is a spatial foveation map according to an embodiment of the present invention.

FIG. 8A is a simplified computational flow diagram for performing spatial foveation based on eye gaze according to an embodiment of the present invention.

FIG. 8B is a schematic diagram illustrating a system for performing spatial foveation based on eye gaze according to an embodiment of the present invention.

FIG. 9 is a simplified flowchart illustrating a method of performing spatial foveation based on eye gaze location according to an embodiment of the present invention.

FIG. 10A is an original image prior to spatial foveation.

FIG. 10B is a spatially foveated image according to an embodiment of the present invention.

FIG. 10C is a restored image according to an embodiment of the present invention.

FIG. 11 is a simplified block diagram illustrating components of an AR system according to an embodiment of the present invention.

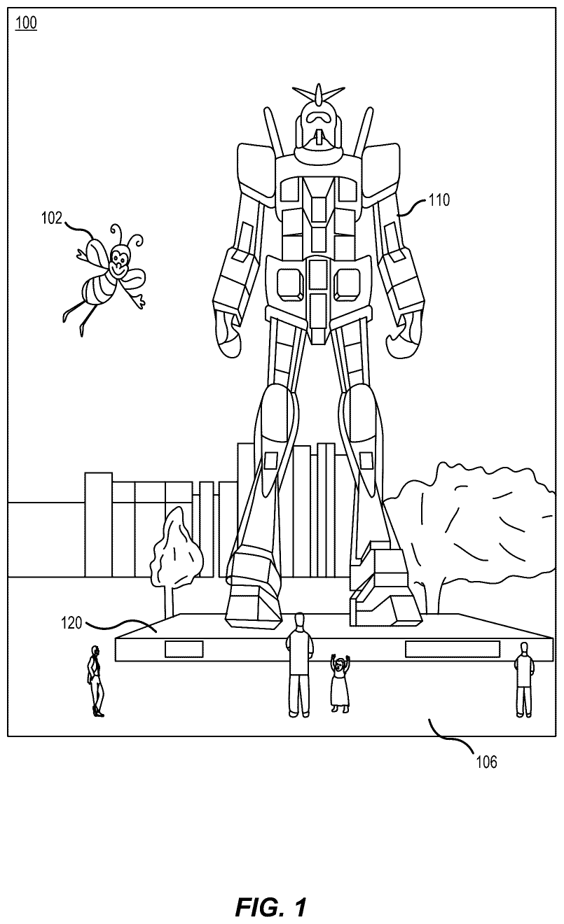

### DETAILED DESCRIPTION OF SPECIFIC EMBODIMENTS

The present invention relates generally to methods and systems related to projection display systems including wearable displays. More particularly, embodiments of the present invention provide methods and systems that utilize eye gaze location during spatial foveation and spatial defoveation processes to reduce memory access to memory, internal data movement, and save power in augmented reality (AR) systems. The spatial defoveation process is performed using the warp reprojection processor that also warps the image to be displayed based on the head pose of the wearable device. Embodiments of the present invention are applicable to a variety of applications in computer vision and image display systems and light field projection systems, including stereoscopic systems, systems that deliver beamlets of light to the retina of the user, or the like.

As described herein, embodiments of the present invention combine the concept of spatial foveation (i.e., reduced image or video quality at regions of an image or video where the human eye is not focused) with the concept of warp correction utilized for head pose correction and other image processing functions, including, but not limited to lens correction, color correction, and the like. As a result, embodiments of the present invention are able to drastically save power when moving display data as well as when processing video imagery. Thus, embodiments of the present invention extend the late stage warp process, which is utilized to perform image correction based on head pose to reduce image jitter and improve pixel stick, to include a foveation decompression to reverse a spatial foveation that was previously performed based on eye gaze location.

Embodiments of the present invention are applicable to systems that perform color foveation, which maintains the total pixel count, but reduces overall compute load, as well as spatial foveation, which reduces the overall resolution and pixel count. As described more fully herein, the first stage warp, which occurs at a remote location, performs a prediction of the future head pose position. The final stage warp then corrects this future prediction based on an actual, corrected head pose measurement. This final stage warps the image from the location where it was predicted to be to the location where it actually should be. According to embodiments of the present invention, both the first stage warp and the final stage warp are modified. The first stage warp processor is modified to perform color space foveation and/or spatial foveation. This spatial foveation results in compression of the image to a reduced-size image (i.e., an image with a reduced number of pixels). The memory and power utilized to transmit this reduced-size image between various system elements, store this reduced-size image, and the like are reduced and the reduced-size image is restored, for example, to the original image size, prior to being rendered for display. Thus, at the late stage warp processor, spatial defoveation and/or color defoveation are performed, restoring the image, for example, to the original image dimensions, in conjunction with image warping, which implements head pose correction and/or other image correction processes prior to the image being displayed.

Reference will now be made to the drawings, in which like reference numerals refer to like parts throughout. Unless indicated otherwise, the drawings are schematic not necessarily drawn to scale.

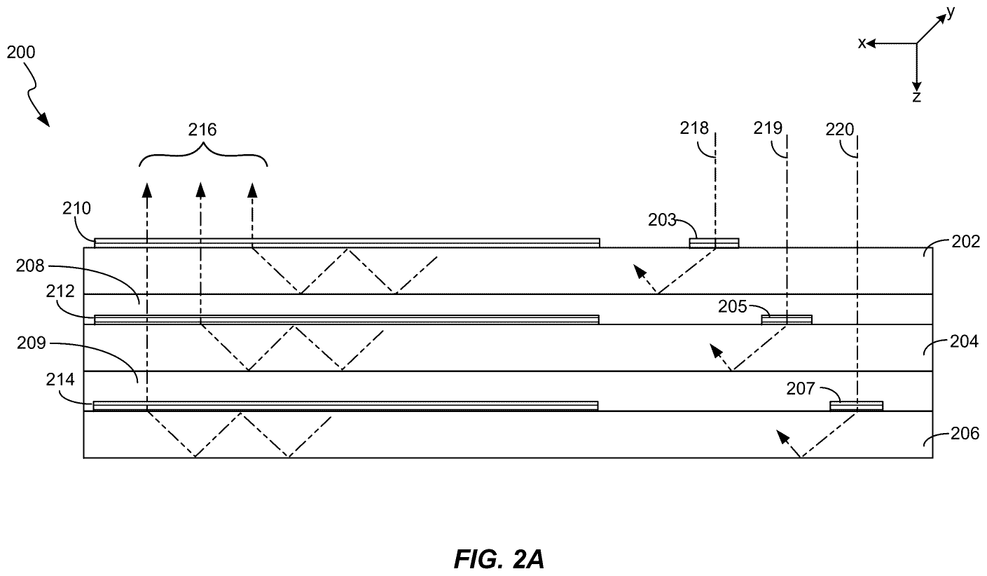

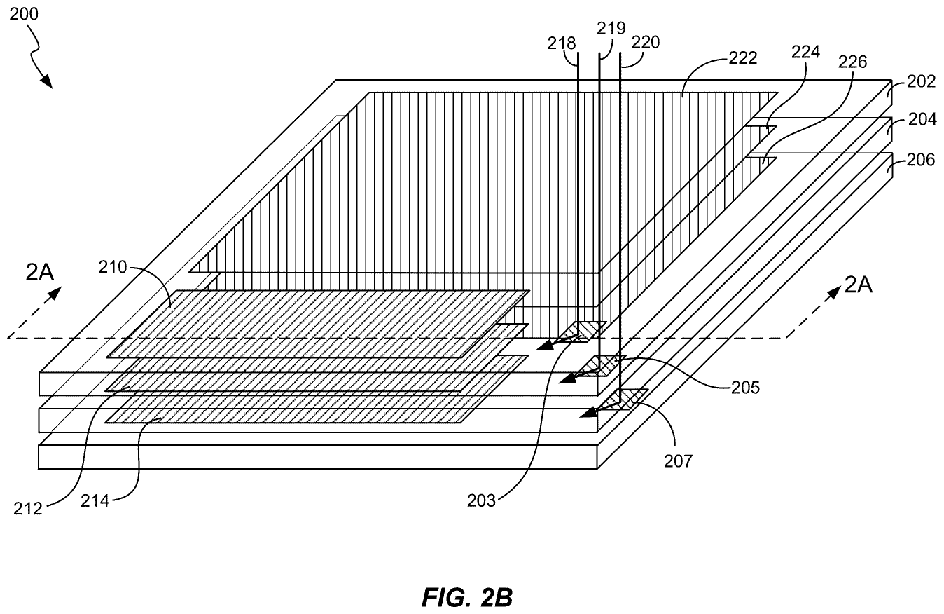

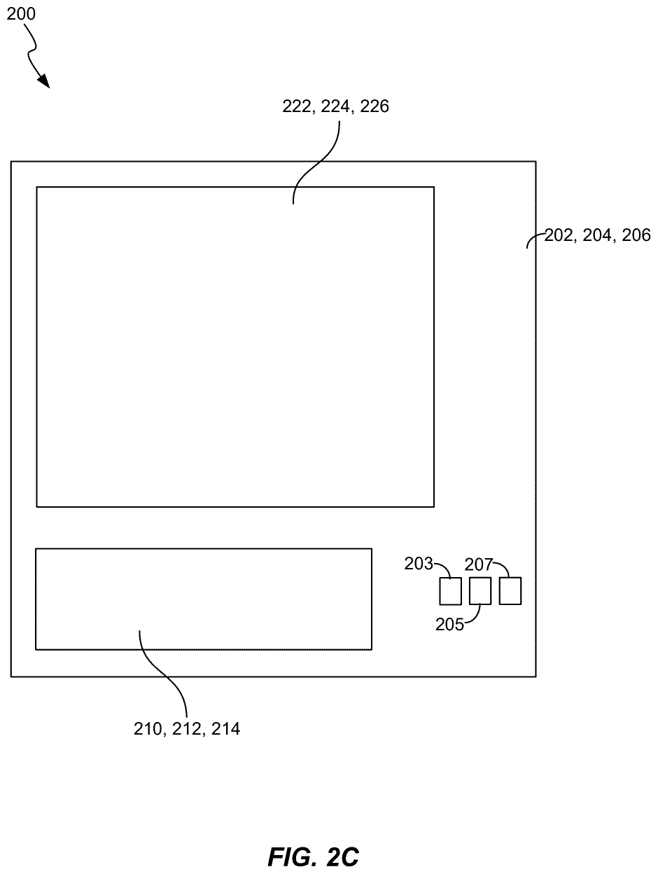

With reference now to FIG. 2A, in some embodiments, light impinging on a waveguide may need to be redirected to incouple that light into the waveguide. An incoupling optical element may be used to redirect and incouple the light into its corresponding waveguide. Although referred to as “incoupling optical element” through the specification, the incoupling optical element need not be an optical element and may be a non-optical element. FIG. 2A illustrates a cross-sectional, side view of an example of a set of stacked waveguides 200 that each includes an incoupling optical element. The waveguides may each be configured to output light of one or more different wavelengths, or one or more different ranges of wavelengths. Light from a projector is injected into the set of stacked waveguides 200 and outcoupled to a user as described more fully below.

The illustrated set of stacked waveguides 200 includes waveguide 202, waveguide 204, and waveguide 206. Each waveguide includes an associated incoupling optical element (which may also be referred to as a light input area on the waveguide), with, e.g., incoupling optical element 203 disposed on a major surface (e.g., an upper major surface) of waveguide 202, incoupling optical element 205 disposed on a major surface (e.g., an upper major surface) of waveguide 204, and incoupling optical element 207 disposed on a major surface (e.g., an upper major surface) of waveguide 206. In some embodiments, one or more of the incoupling optical elements may be disposed on the bottom major surface of the respective waveguide (particularly where the one or more incoupling optical elements are reflective, deflecting optical elements). As illustrated, the incoupling optical element 203, the incoupling optical element 205, and the incoupling optical element 207 may be disposed on the upper major surface of waveguide 202, waveguide 204, and waveguide 206, respectively (or the top of the next lower waveguide), particularly where those incoupling optical elements are transmissive, deflecting optical elements. In some embodiments, the incoupling optical element 203, the incoupling optical element 205, and the incoupling optical element 207 may be disposed in the body of the waveguide 202, waveguide 204, and waveguide 206, respectively. In some embodiments, as discussed herein, the incoupling optical element 203, the incoupling optical element 205, and the incoupling optical element 207 are wavelength-selective, such that they selectively redirect one or more wavelengths of light, while transmitting other wavelengths of light. While illustrated on one side or corner of waveguide 202, waveguide 204, and waveguide 206, respectively, it will be appreciated that the incoupling optical element 203, the incoupling optical element 205, and the incoupling optical element 207 may be disposed in other areas of waveguide 202, waveguide 204, and waveguide 206, respectively, in some embodiments.

As illustrated, the incoupling optical element 203, the incoupling optical element 205, and the incoupling optical element 207 may be laterally offset from one another. In some embodiments, each incoupling optical element may be offset such that it receives light without that light passing through another incoupling optical element. For example, each of the incoupling optical element 203, the incoupling optical element 205, and the incoupling optical element 207 may be configured to receive light from a different projector and may be separated (e.g., laterally spaced apart) from other incoupling optical elements such that it substantially does not receive light from the other ones of the incoupling optical elements.

Each waveguide also includes associated light distributing elements, with, e.g., light distributing elements 210 disposed on a major surface (e.g., a top major surface) of waveguide 202, light distributing elements 212 disposed on a major surface (e.g., a top major surface) of waveguide 204, and light distributing elements 214 disposed on a major surface (e.g., a top major surface) of waveguide 206. In some other embodiments, the light distributing elements 210, the light distributing elements 212, and the light distributing elements 214 may be disposed on a bottom major surface of associated waveguide 202, waveguide 204, and waveguide 206, respectively. In some other embodiments, the light distributing elements 210, the light distributing elements 212, and the light distributing elements 214 may be disposed on both top and bottom major surfaces of associated waveguide 202, waveguide 204, and waveguide 206, respectively; or the light distributing elements 210, the light distributing elements 212, and the light distributing elements 214 may be disposed on different ones of the top and bottom major surfaces in different associated waveguide 202, waveguide 204, and waveguide 206, respectively.

Waveguide 202, waveguide 204, and waveguide 206 may be spaced apart and separated by, e.g., gas, liquid, and/or solid layers of material. For example, as illustrated in FIG. 2A, layer 208 may separate waveguide 202 and waveguide 204 and layer 209 may separate waveguide 204 and waveguide 206. In some embodiments, layer 208 and layer 209 are formed of low refractive index materials (that is, materials having a lower refractive index than the material forming the immediately adjacent one of waveguide 202, waveguide 204, or waveguide 206). Preferably, the refractive index of the material forming layer 208 and/or layer 209 is 0.05 or more, or 0.10 or less than the refractive index of the material forming the waveguide 202, the waveguide 204, or the waveguide 206. Advantageously, layer 208 and layer 209 having the lower refractive index may function as cladding layers that facilitate total internal reflection (TIR) of light through the waveguide 202, the waveguide 204, and the waveguide 206 (e.g., TIR between the top and bottom major surfaces of each waveguide). In some embodiments, the layer 208 and the layer 209 are formed of air. While not illustrated, it will be appreciated that the top and bottom of the illustrated set of stacked waveguides 200 may include immediately neighboring cladding layers.

Preferably, for ease of manufacturing and other considerations, the material forming the waveguide 202, the waveguide 204, and the waveguide 206 are similar or the same, and the material forming the layer 208 and the layer 209 are similar or the same. In some embodiments, the material forming the waveguide 202, the waveguide 204, and the waveguide 206 may be different between one or more waveguides, and/or the material forming the layer 208 and the layer 209 may be different, while still holding to the various refractive index relationships noted above.

With continued reference to FIG. 2A, light ray 218, light ray 219, and light ray 220 are incident on the set of stacked waveguides 200. It will be appreciated that the light ray 218, the light ray 219, and the light ray 220 may be injected into the waveguide 202, the waveguide 204, and the waveguide 206 by one or more projectors (not shown).

In some embodiments, light ray 218, the light ray 219, and the light ray 220 have different properties, e.g., different wavelengths or different ranges of wavelengths, which may correspond to different colors. The incoupling optical element 203, the incoupling optical element 205, and the incoupling optical element 207 each deflect the incident light such that the light propagates through a respective one of the waveguide 202, the waveguide 204, or the waveguide 206 by TIR. In some embodiments, the incoupling optical element 203, the incoupling optical element 205, and the incoupling optical element 207 each selectively deflect one or more particular wavelengths of light, while transmitting other wavelengths to an underlying waveguide and associated incoupling optical element.

For example, incoupling optical element 203 may be configured to deflect light ray 218, which has a first wavelength or range of wavelengths, while transmitting light ray 219 and light ray 220, which have different second and third wavelengths or ranges of wavelengths, respectively. The light ray 219 transmitted through the waveguide 202 impinges on and is deflected by the incoupling optical element 205, which is configured to deflect light of a second wavelength or range of wavelengths. The light ray 220 is deflected by the incoupling optical element 207, which is configured to selectively deflect light of third wavelength or range of wavelengths.

With continued reference to FIG. 2A, the light ray 218, the light ray 219, and the light ray 220 are deflected such that they propagate through corresponding waveguide 202, waveguide 204, and waveguide 206, respectively; that is, the incoupling optical element 203, the incoupling optical element 205, and the incoupling optical element 207 of each waveguide deflects light into the corresponding waveguide 202, waveguide 204, or waveguide 206 to incouple light into that corresponding waveguide. The light ray 218, the light ray 219, and the light ray 220 are deflected at angles that cause the light to propagate through the respective waveguide 202, waveguide 204, and waveguide 206 by TIR. The light ray 218, the light ray 219, and the light ray 220 propagate through the respective waveguide 202, waveguide 204, and waveguide 206 by TIR until impinging on the waveguide's corresponding light distributing elements: the light distributing elements 210, the light distributing elements 212, and the light distributing elements 214, where they are outcoupled to provide out-coupled light rays 216.

With reference now to FIG. 2B, a perspective view of an example of the set of stacked waveguides 200 of FIG. 2A is illustrated. As noted above, the light ray 218, the light ray 219, and the light ray 220 are incoupled and deflected by the incoupling optical element 203, the incoupling optical element 205, and the incoupling optical element 207, respectively, and then propagate by TIR within the waveguide 202, the waveguide 204, and the waveguide 206, respectively. The light ray 218, the light ray 219, and the light ray 220 then impinge on the light distributing elements 210, the light distributing elements 212, and the light distributing elements 214, respectively. The light distributing elements 210, the light distributing elements 212, and the light distributing elements 214 deflect the light ray 218, the light ray 219, and the light ray 220 so that they propagate towards the outcoupling optical elements 222, the outcoupling optical elements 224, and the outcoupling optical elements 226, respectively.

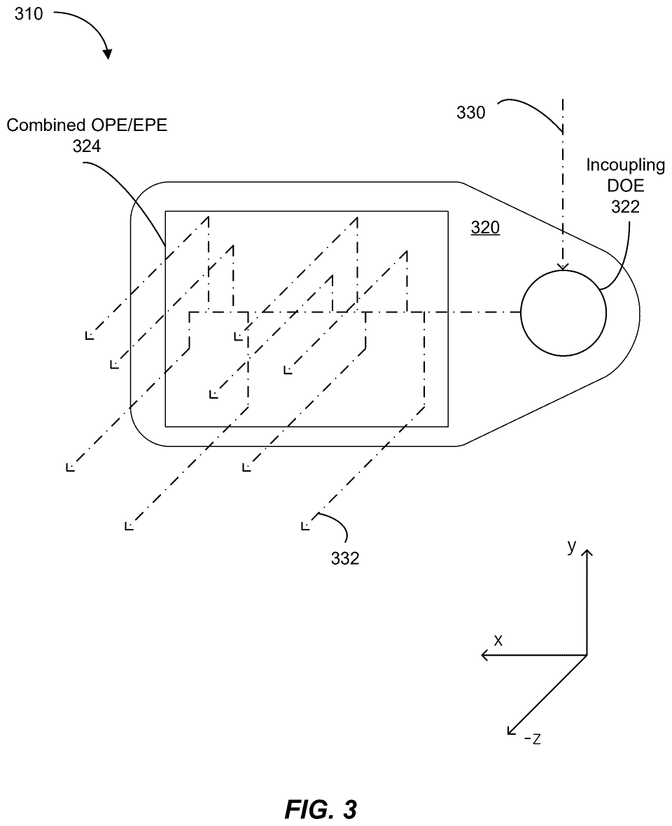

In some embodiments, the light distributing elements 210, the light distributing elements 212, and the light distributing elements 214 are orthogonal pupil expanders (OPEs). In some embodiments, the OPEs deflect or distribute light to the outcoupling optical elements 222, the outcoupling optical elements 224, and the outcoupling optical elements 226 and, in some embodiments, may also increase the beam or spot size of this light as it propagates to the outcoupling optical elements. In some embodiments, the light distributing elements 210, the light distributing elements 212, and the light distributing elements 214 may be omitted and the incoupling optical element 203, the incoupling optical element 205, and the incoupling optical element 207 may be configured to deflect light directly to the outcoupling optical elements 222, the outcoupling optical elements 224, and the outcoupling optical elements 226. For example, with reference to FIG. 2A, the light distributing elements 210, the light distributing elements 212, and the light distributing elements 214 may be replaced with the outcoupling optical elements 222, the outcoupling optical elements 224, and the outcoupling optical elements 226, respectively. In some embodiments, the outcoupling optical elements 222, the outcoupling optical elements 224, and the outcoupling optical elements 226 are exit pupils (EPs) or exit pupil expanders (EPEs) that direct light to the eye of the user. It will be appreciated that the OPEs may be configured to increase the dimensions of the eye box in at least one axis and the EPEs may be configured to increase the eye box in an axis crossing, e.g., orthogonal to, the axis of the OPEs. For example, each OPE may be configured to redirect a portion of the light striking the OPE to an EPE of the same waveguide, while allowing the remaining portion of the light to continue to propagate down the waveguide. Upon impinging on the OPE again, another portion of the remaining light is redirected to the EPE, and the remaining portion of that portion continues to propagate further down the waveguide, and so on. Similarly, upon striking the EPE, a portion of the impinging light is directed out of the waveguide towards the user, and a remaining portion of that light continues to propagate through the waveguide until it strikes the EPE again, at which time another portion of the impinging light is directed out of the waveguide, and so on. Consequently, a single beam of incoupled light may be “replicated” each time a portion of that light is redirected by an OPE or EPE, thereby forming a field of cloned beams of light. In some embodiments, the OPE and/or EPE may be configured to modify a size of the beams of light. In some embodiments, the functionality of the light distributing elements 210, the light distributing elements 212, and the light distributing elements 214 and the outcoupling optical elements 222, the outcoupling optical elements 224, and the outcoupling optical elements 226 are combined in a combined pupil expander as discussed in relation to FIG. 3.

Accordingly, with reference to FIGS. 2A and 2B, in some embodiments, the set of stacked waveguides 200 includes the waveguide 202, the waveguide 204, and the waveguide 206; the incoupling optical element 203, the incoupling optical element 205, and the incoupling optical element 207; the light distributing elements 210, the light distributing elements 212, and the light distributing elements 214 (e.g., OPEs); and the outcoupling optical elements 222, the outcoupling optical elements 224, and the outcoupling optical elements 226 (e.g., EPs) for each component color. The waveguide 202, the waveguide 204, and the waveguide 206 may be stacked with an air gap/cladding layer between each one. The incoupling optical element 203, the incoupling optical element 205, and the incoupling optical element 207 redirect or deflect incident light (with different incoupling optical elements receiving light of different wavelengths) into its waveguide. The light then propagates at an angle which will result in TIR within the waveguide 202, the waveguide 204, and the waveguide 206, respectively. In the example shown, light ray 218 (e.g., blue light) is deflected by the incoupling optical element 203, and then continues to bounce down the waveguide, interacting with the light distributing element 210 (e.g., OPEs) and then the outcoupling optical element 222 (e.g., EPs), in a manner described earlier. The light ray 219 and the light ray 220 (e.g., green and red light, respectively) will pass through the waveguide 202, with light ray 219 impinging on and being deflected by incoupling optical element 205. The light ray 219 then bounces down the waveguide 204 via TIR, proceeding on to its light distributing element 212 (e.g., OPEs) and then the outcoupling optical element 224 (e.g., EPs). Finally, light ray 220 (e.g., red light) passes through the waveguide 206 to impinge on the incoupling optical element 207 of the waveguide 206. The incoupling optical element 207 deflects the light ray 220 such that the light ray propagates to light distributing element 214 (e.g., OPEs) by TIR, and then to the outcoupling optical element 226 (e.g., EPs) by TIR. The outcoupling optical element 226 then finally out-couples the light ray 220 to the viewer, who also receives the outcoupled light from the other waveguides: the waveguide 202 and the waveguide 204.

FIG. 2C illustrates a top-down, plan view of an example of the set of stacked waveguides 200 of FIGS. 2A and 2B. As illustrated, the waveguide 202, the waveguide 204, and the waveguide 206, along with each waveguide's associated light distributing element: the light distributing element 210, light distributing element 212, and light distributing element 214 and the associated outcoupling optical elements: the outcoupling optical elements 222, the outcoupling optical elements 224, and the outcoupling optical elements 226, may be vertically aligned. However, as discussed herein, the incoupling optical element 203, the incoupling optical element 205, and the incoupling optical element 207 are not vertically aligned; rather, the incoupling optical elements are preferably nonoverlapping (e.g., laterally spaced apart as seen in the top-down or plan view). As discussed further herein, this nonoverlapping spatial arrangement facilitates the injection of light from different resources into different waveguides on a one-to-one basis, thereby allowing a specific light source to be uniquely coupled to a specific waveguide. In some embodiments, arrangements including nonoverlapping spatially separated incoupling optical elements may be referred to as a shifted pupil system, and the incoupling optical elements within these arrangements may correspond to sub pupils.

FIG. 3 is a simplified illustration of an eyepiece waveguide having a combined pupil expander according to an embodiment of the present invention. In the example illustrated in FIG. 3, the eyepiece 310 utilizes a combined OPE/EPE region in a single-side configuration. Referring to FIG. 3, the eyepiece 310 includes a substrate 320 in which incoupling optical element 322 and a combined OPE/EPE region 324, also referred to as a combined pupil expander (CPE), are provided. Incident light ray 330 is incoupled via the incoupling optical element 322 and outcoupled as output light rays 332 via the combined OPE/EPE region 324.

The combined OPE/EPE region 324 includes gratings corresponding to both an OPE and an EPE that spatially overlap in the x-direction and the y-direction. In some embodiments, the gratings corresponding to both the OPE and the EPE are located on the same side of a substrate 320 such that either the OPE gratings are superimposed onto the EPE gratings or the EPE gratings are superimposed onto the OPE gratings (or both). In other embodiments, the OPE gratings are located on the opposite side of the substrate 320 from the EPE gratings such that the gratings spatially overlap in the x-direction and the y-direction but are separated from each other in the z-direction (i.e., in different planes). Thus, the combined OPE/EPE region 324 can be implemented in either a single-sided configuration or in a two-sided configuration.

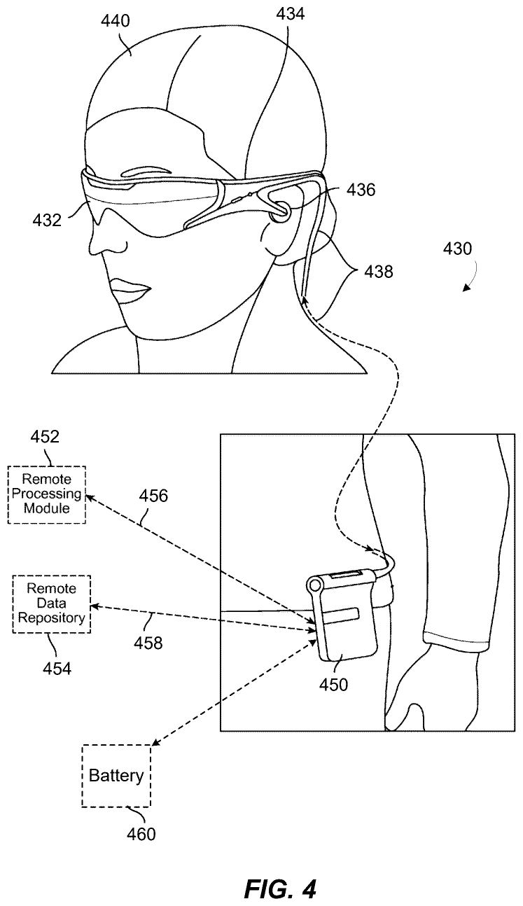

FIG. 4 illustrates an example of wearable display system 430 into which the various waveguides and related systems disclosed herein may be integrated. With reference to FIG. 4, the wearable display system 430 includes a display 432, and various mechanical and electronic modules and systems to support the functioning of the display 432. The display 432 may be coupled to a frame 434, which is wearable by a user 440 (also referred to as a viewer or a display system user) and which is configured to position the display 432 in front of the eyes of the user 440. The display 432 may be considered eyewear in some embodiments. In some embodiments, a speaker 436 is coupled to the frame 434 and configured to be positioned adjacent the car canal of the user 440 (in some embodiments, another speaker, not shown, may optionally be positioned adjacent the other car canal of the user to provide stereo/shapeable sound control). The wearable display system 430 may also include one or more microphones or other devices to detect sound. In some embodiments, the microphone is configured to allow the user to provide inputs or commands to the wearable display system 430 (e.g., the selection of voice menu commands, natural language questions, etc.), and/or may allow audio communication with other persons (e.g., with other users of similar display systems). The microphone may further be configured as a peripheral sensor to collect audio data (e.g., sounds from the user and/or environment). In some embodiments, the wearable display system 430 may further include one or more outwardly directed environmental sensors configured to detect objects, stimuli, people, animals, locations, or other aspects of the world around the user. For example, environmental sensors may include one or more cameras, which may be located, for example, facing outward so as to capture images similar to at least a portion of an ordinary field of view of the user 440. In some embodiments, the wearable display system may also include a peripheral sensor, which may be separate from the frame 434 and attached to the body of the user 440 (e.g., on the head, torso, an extremity, etc. of the user 440). The peripheral sensor may be configured to acquire data characterizing a physiological state of the user 440 in some embodiments. For example, the sensor may be an electrode.

The display 432 is operatively coupled by a communications link, such as by a wired lead or wireless connectivity, to a local data processing module which may be mounted in a variety of configurations, such as fixedly attached to the frame 434, fixedly attached to a helmet or hat worn by the user, embedded in headphones, or otherwise removably attached to the user 440 (e.g., in a backpack-style configuration, in a belt-coupling style configuration). Similarly, the sensor may be operatively coupled by a communications link, e.g., a wired lead or wireless connectivity, to the local processor and data module. The local processing and data module may comprise a hardware processor, as well as digital memory, such as non-volatile memory (e.g., flash memory or hard disk drives), both of which may be utilized to assist in the processing, caching, and storage of data. Optionally, the local processor and data module may include one or more central processing units (CPUs), graphics processing units (GPUs), dedicated processing hardware, and so on. The data may include data a) captured from sensors (which may be, e.g., operatively coupled to the frame 434 or otherwise attached to the user 440), such as image capture devices (such as cameras), microphones, inertial measurement units, accelerometers, compasses, GPS units, radio devices, gyros, and/or other sensors disclosed herein; and/or b) acquired and/or processed using remote processing module 452 and/or remote data repository 454 (including data relating to virtual content), possibly for passage to the display 432 after such processing or retrieval. The local processing and data module may be operatively coupled by communication links 438 such as via wired or wireless communication links, to the remote processing and data module 450, which can include the remote processing module 452, the remote data repository 454, and a battery 460. The remote processing module 452 and the remote data repository 454 can be coupled by communication links 456 and communication links 458 to remote processing and data module 450 such that these remote modules are operatively coupled to each other and available as resources to the remote processing and data module 450. In some embodiments, the remote processing and data module 450 may include one or more of the image capture devices, microphones, inertial measurement units, accelerometers, compasses, GPS units, radio devices, and/or gyros. In some other embodiments, one or more of these sensors may be attached to the frame 434, or may be standalone structures that communicate with the remote processing and data module 450 by wired or wireless communication pathways.

With continued reference to FIG. 4, in some embodiments, the remote processing and data module 450 may comprise one or more processors configured to analyze and process data and/or image information, for instance including one or more central processing units (CPUs), graphics processing units (GPUs), dedicated processing hardware, and so on. In some embodiments, the remote data repository 454 may comprise a digital data storage facility, which may be available through the internet or other networking configuration in a “cloud” resource configuration. In some embodiments, the remote data repository 454 may include one or more remote servers, which provide information, e.g., information for generating augmented reality content, to the local processing and data module and/or the remote processing and data module 450. In some embodiments, all data is stored and all computations are performed in the local processing and data module, allowing fully autonomous use from a remote module. Optionally, an outside system (e.g., a system of one or more processors, one or more computers) that includes CPUs, GPUs, and so on, may perform at least a portion of processing (e.g., generating image information, processing data) and provide information to, and receive information from, the illustrated modules, for instance, via wireless or wired connections.

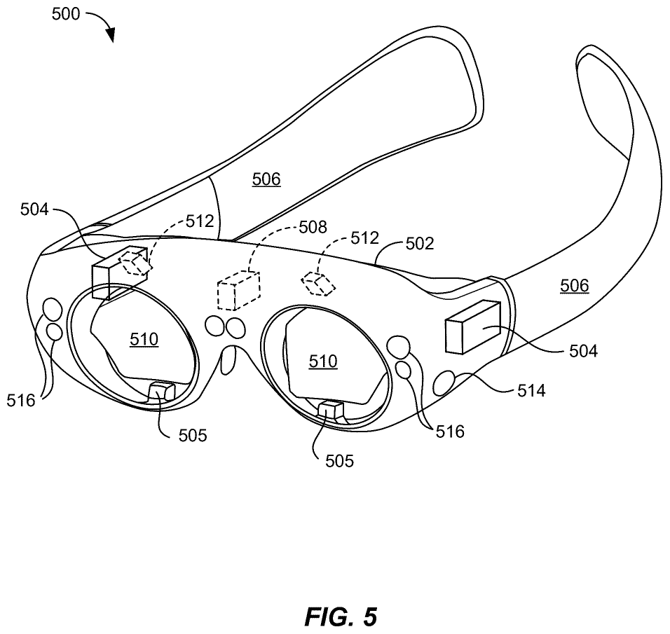

FIG. 5 shows a perspective view of a wearable device 500 according to an embodiment of the present invention. Wearable device 500 includes a frame 502 configured to support one or more projectors 504 at various positions along an interior-facing surface of frame 502, as illustrated. In some embodiments, projectors 504 can be attached at positions near temples 506. Alternatively, or in addition, another projector could be placed in position 508. Such projectors may, for instance, include or operate in conjunction with one or more liquid crystal on silicon (LCoS) modules, micro-LED displays, or fiber scanning devices. In some embodiments, light from projectors 504 or projectors disposed in position 508 could be guided into eyepieces 510 for display to eyes of a user. Projectors placed at positions 512 can be somewhat smaller on account of the close proximity this gives the projectors to the waveguide system. The closer proximity can reduce the amount of light lost as the waveguide system guides light from the projectors to eyepiece 510. In some embodiments, the projectors at positions 512 can be utilized in conjunction with projectors 504 or projectors disposed in position 508. While not depicted, in some embodiments, projectors could also be located at positions beneath eyepieces 510. Wearable device 500 is also depicted including sensors 514 and sensors 516. Sensors 514 and sensors 516 can take the form of forward-facing and lateral-facing optical sensors configured to characterize the real-world environment surrounding wearable device 500.

Embodiments of the present invention utilize an eye tracking system to determine the eye gaze location of the user and utilize the eye gaze location for image compression processes. Referring to FIG. 5, eye tracking cameras 505 are located on the frame 502 and can be utilized to track the eye gaze location of the user using the wearable device 500. In other embodiments, other eye tracking systems are utilized to determine the eye gaze location and the eye tracking cameras 505 illustrated in FIG. 5 are merely exemplary. As described more fully herein, the image compression processes utilized to compress and decompress virtual content for storage in memory, internal communications, and display, among other functions, can be modified depending on the eye gaze location, for example, portions of an image or video stream corresponding to the eye gaze location can be compressed using a higher quality compression process compared to other portions of the image or video stream that are located more distant from the eye gaze location. Since these more distant portions of the image or video stream are in the user's peripheral vision, any impact on the user experience resulting from the reduction in compression quality can be less than the benefits achieved in terms of memory and processing efficiency and/or requirements. One of ordinary skill in the art would recognize many variations, modifications, and alternatives.

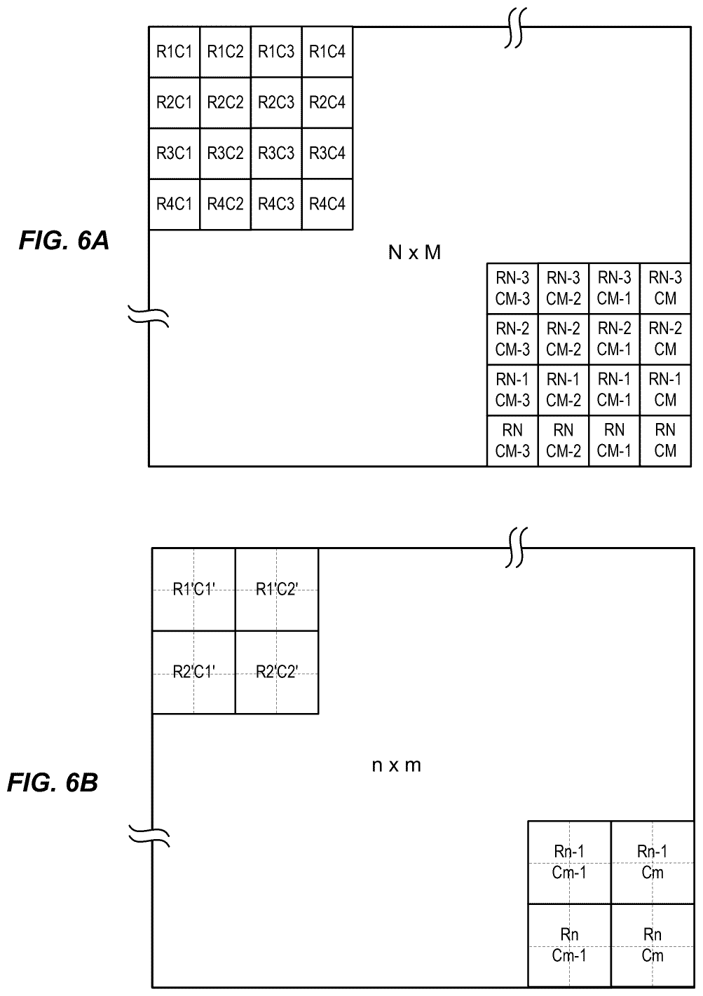

FIG. 6A is an example of an original N×M image. FIG. 6B is a spatially foveated n×m image according to an embodiment of the present invention.

In spatial foveation applications, a plurality of pixels, for example four pixels, are compressed into a single pixel. As illustrated in FIGS. 6A and 6B, the 16 pixels in the top left corner and the 16 pixels in the bottom right corner of the image shown in FIG. 6A are compressed to four pixels in the top left corner and four pixels in the bottom right corner of the image shown in FIG. 6B. Referring to the top left corner of FIGS. 6A and 6B, pixels R1C1, R1C2, R2C1, and R2C2 are compressed to pixel R1′C1′; pixels R1C3, R1C4, R2C3, and R2C4 are compressed to pixel R1′C2′; pixels R3C1, R3C2, R4C1, and R4C2 are compressed to pixel R2′C1′; and pixels R3C3, R3C4, R4C3, and R4C4 are compressed to pixel R2′C2′. Similarly, referring to the bottom right corner of FIGS. 6A and 6B, pixels RN-3CM-3, RN-3CM-2, RN-2CM-3, and RN-2CM-2 are compressed to pixel Rn-1Cm-1; pixels RN-3CM-1, RN-3CM, RN-2CM-1, and RN-2CM are compressed to pixel Rn-1Cm; pixels RN-1CM-3, RN-1CM-2, RNCM-3, and RNCM-2 are compressed to pixel RnCm-1; and pixels RN-1CM-1, RN-1CM, RNCM-1, and RNCM are compressed to pixel RnCm.

Thus, spatial foveation reduces the pixel count, thereby reducing processing and memory requirements at the expense of a reduction in resolution. After application of spatial foveation, the size of the image will be reduced as a result of the spatial foveation. In embodiments discussed herein, spatial foveation is applied non-uniformly as a function of the image location, with reduced or no foveation performed at the location corresponding to the eye gaze (i.e., the eye gaze location) and increased spatial foveation performed at locations more distant from the eye gaze location. The spatial defoveation will be performed in an inverse manner, with multiple pixels being generated based on a single pixel. The spatial defoveation will also be non-uniformly applied across the image. One of ordinary skill in the art would recognize many variations, modifications, and alternatives.

Referring to FIGS. 6A and 6B, the illustrated spatial foveation process combines a plurality of pixels (e.g., four pixels) into a single pixel. This spatial foveation process is performed based on the eye gaze location, with higher compression in regions of the image farther from the eye gaze location. Thus, in the corners of the N×M image shown in FIG. 6A, the sixteen original pixels will be compressed to four pixels. During the spatial defoveation process, the process is reversed, with a single pixel being used to generate a plurality of pixels (e.g., four pixels). As described more fully herein, the spatial defoveation process is performed by the warp processor, which also performs head pose correction and other image correction processes prior to the image being displayed.

In some embodiments, in addition to or as an alternative to spatial foveation, color space foveation is implemented. Color space foveation, which can be utilized to reduce computational requirements, assigns the color of one of a plurality of pixels to the pixels making up the plurality of pixels, illustrated by the color of one pixel (e.g., pixel (1,1)) being assigned to the other pixels in the plurality of pixels (e.g., pixel (1,2), pixel (2,1), and pixel (2,2)). As a result of color space foveation in this example, all four pixels are assigned the color of one original pixel. Accordingly, the number of pixels remains the same and, as a result, an image on which color space foveation has been performed will retain the original image size, but have a reduced color content. In some embodiments, color space foveation is utilized to assign a single color to multiple pixels in combination with spatial foveation, which is utilized to reduce the pixel count in the color space/spatially foveated image. During the decompression phase, both color space foveation and spatial foveation are reversed. One of ordinary skill in the art would recognize many variations, modifications, and alternatives.

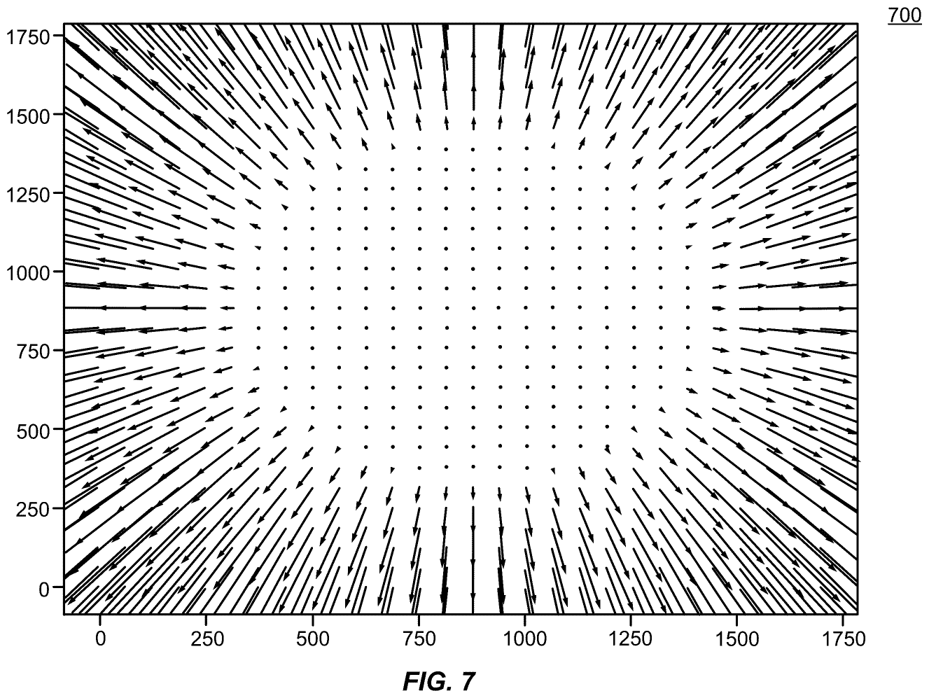

FIG. 7 is a spatial foveation map according to an embodiment of the present invention. The spatial foveation map 700 illustrated in FIG. 7 can be created based on eye gaze information, namely, by being able to actively tell where the human eye is currently focused or looking.

As described herein, the length of the spatial foveation vectors represented by spatial foveation map 700 is a function of the eye gaze location. For the spatial foveation map 700 illustrated in FIG. 7, the eye gaze location is the center of the image (i.e., pixel (900,900), which may also be referred to as a central region. Pixels in the vicinity of the eye gaze location receive reduced or no spatial foveation. Thus, after spatial foveation, pixel (900,900) is unchanged. Pixels near pixel (900,900) correspond to a short foveation vector. Accordingly, the magnitude of spatial foveation for pixels near the center pixel is small, resulting in a small number of pixels being represented by a single pixel after the spatial foveation process.

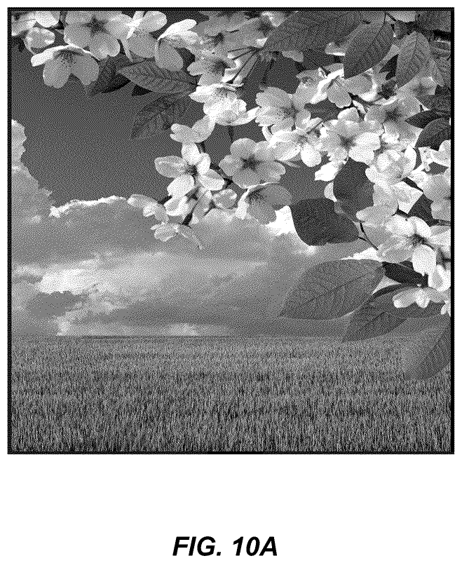

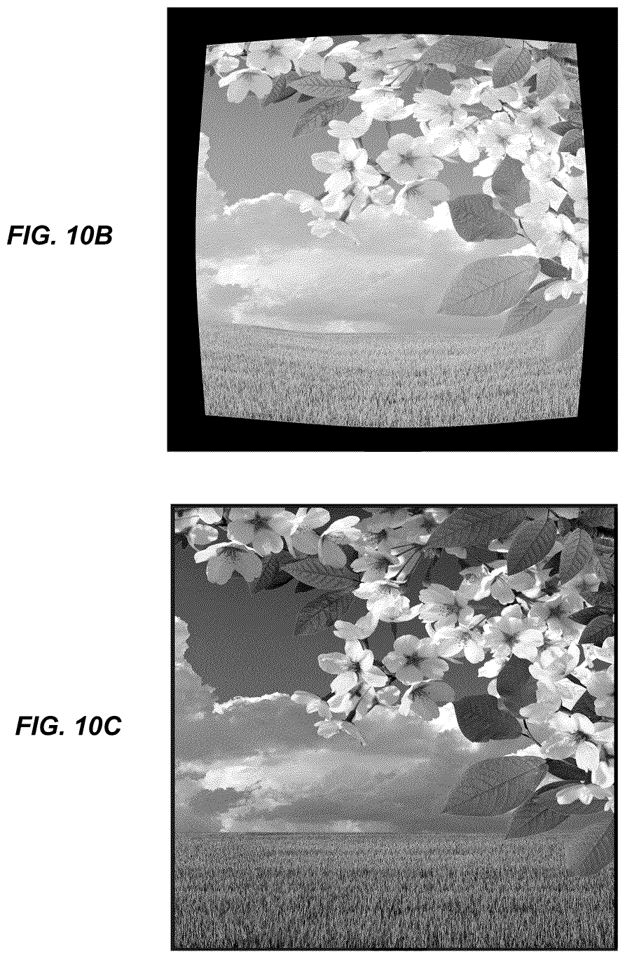

As the distance between a given pixel and the eye gaze location increases, the magnitude of the spatial foveation vector increases, which corresponds to the magnitude of the spatial foveation increasing as illustrated in FIG. 7. Thus, the magnitude of the spatial foveation vectors, and the corresponding magnitude of the spatial foveation, are largest in the corners of the image adjacent pixel (0,0), pixel (1800,0), (pixel 0,1800), and pixel (1800,1800), which may be referred to as the peripheral region. Accordingly, for these pixels in the peripheral region, spatial foveation is performed by grouping a larger number of pixels (i.e., a number of pixels corresponding to the length of the foveation vector) to form a single pixel. As a result, the pixel count decreases as a function of distance from the eye gaze location as illustrated in FIG. 10B discussed below.

The spatial foveation map 700 can be dynamic, changing as a function of the eye gaze location. As an example, if the eye gaze location shifts to the left side of the image, the area of reduced or no spatial foveation will shift to the left side of the image, with the spatial foveation being performed on pixels on the right side of the image being increased. Thus, as the eye gaze location moves to different locations of the image, the spatial foveation map 700 will be updated in real time, tracking the eye gaze location. As a result, the spatial foveation map 700 illustrated in FIG. 7 is merely exemplary and associated with the eye gaze location being centered on the image. Thus, during operation, the spatial foveation map 700 can be dynamically updated based on the eye gaze location. During the spatial defoveation process, in which multiple pixels are generated based on a single pixel, a spatial defoveation map that is the inverse of the spatial foveation map will be utilized. As a result, the spatial defoveation map can also be dynamically updated based on the eye gaze location. One of ordinary skill in the art would recognize many variations, modifications, and alternatives.

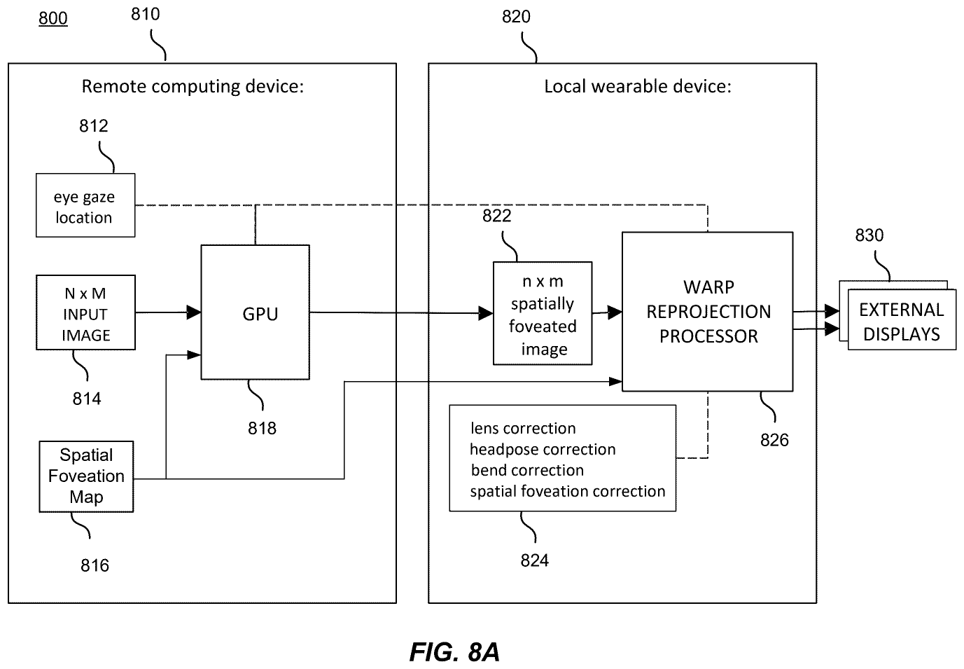

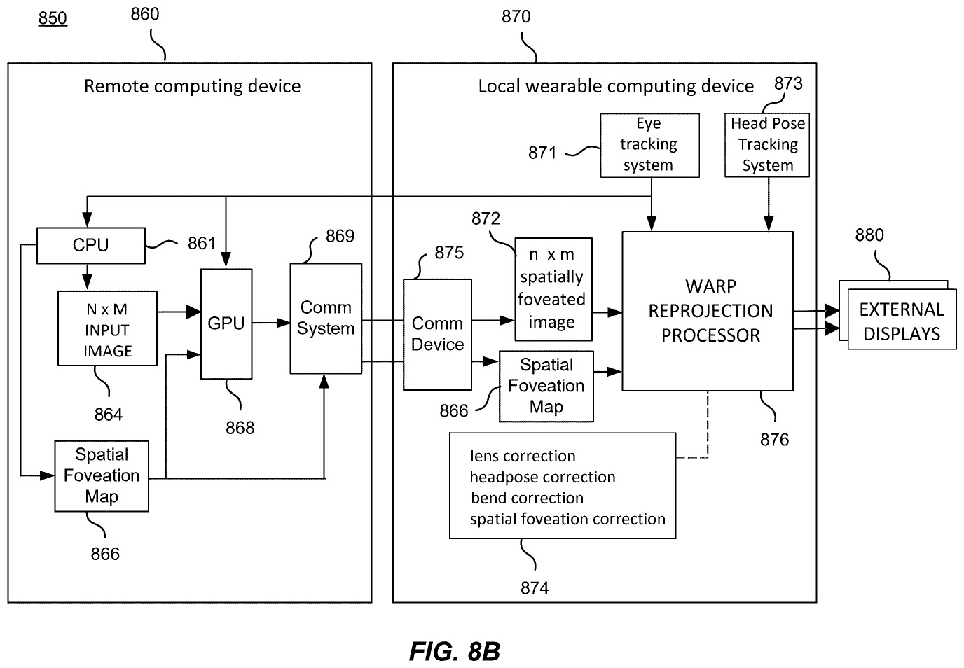

FIG. 8A is a simplified computational flow diagram for performing spatial foveation based on eye gaze according to an embodiment of the present invention. The system 800 illustrated in FIG. 8A includes a remote computing device 810 and a local wearable device 820 that can be utilized to present virtual content to a user. Remote computing device 810 and local wearable device 820 can be elements of an augmented reality (AR) system. Given the eye gaze location 812, spatial foveation map 816, and an N×M input image 814 (e.g., the virtual content), graphics processing unit (GPU) 818 performs spatial foveation based on the eye gaze location 812 and the spatial foveation map 816. This spatial foveation process produces an n×m spatially foveated image 822 that is transmitted from the remote computing device 810 to the local wearable device 820. In embodiments of the present invention, n<N and m<M, for example, the original image is an N=640×M=480 image and the spatially foveated image is an n=480×m=360 image. As a result, the number of pixels in the spatially foveated image 822 is less than the number of pixels in the N×M input image 814.

As illustrated in FIG. 8A, the eye gaze location 812 is provided to remote computing device 810. The n×m spatially foveated image 822 is compressed non-uniformly, with reduced or no spatial compression in the vicinity of the eye gaze location 812 and larger spatial compression for pixels at greater distances from the eye gaze location 812. This reduction in image size is beneficial in several ways, including reduced data transmission bandwidth, reduced processing load, and the like.

In order to provide an image for display to the user, the spatial foveation performed by the GPU 818 is reversed using a spatial defoveation process, also referred to as a spatial foveation correction process. In addition to spatial defoveation, other processes can be performed to generate an image suitable for display to a user. As an example, optical elements utilized in the display may be characterized by distortion. This distortion can be removed by performing a lens correction process. Moreover, since the user's head may have translated and/or rotated during the time between when the virtual content (e.g., the N×M input image) was generated and the time the image is displayed to the user through the one or more external displays 830, a head pose correction process can be performed.

Additionally, in embodiments utilizing eyepiece waveguide displays, the eyepiece waveguide may be characterized by a bend value, which can be corrected using a bend correction process. Bend correction can be utilized to correct for mechanical deformation of the eyepiece, for example, from a planar shape to a non-planar shape. In some embodiments, planar eyepiece waveguides are utilized. The eyepiece waveguides may not have a rigid mechanical structure, but have a malleable frame. Due to one or more factors, the shape of the eyepiece waveguide can deviate from a planar shape to take on a non-planar shape. In other embodiments, the desired shape of the eyepiece waveguide is a non-planar shape, for example, a uniform curvature, but deformation of the eyepiece waveguide may result in the shape being a non-uniform curvature, planar, or the like. Deformations from the desired shape can be present in real-time (i.e., instantaneous) or can develop over time. In any of these cases, the undesired curvature present in the eyepiece waveguide can be measured, stored in a memory, or the like, and a bend correction process can be utilized to warp the image in a manner similar to removal of optical distortion using the lens correction process. Thus, the bend correction discussed herein can correct for eyepiece shape changes, eyepiece movement relative to each other, and/or eyepiece movement relative to the user's eye position. Therefore, as illustrated in FIG. 8A, bend correction is one of the possible corrections that can be performed by the warp reprojection processor 826 (e.g., the late stage reprojection processor) in addition to other corrections that can be performed (e.g., lens, foveation, color, or the like).

As illustrated in FIG. 8A, the eye gaze location 812 is also transmitted to local wearable device 820. Given the n×m spatially foveated image 822, correction inputs 824, which can include lens correction, head pose correction, bend correction, spatial foveation correction, and the like, and the spatial foveation map 816, the warp reprojection processor 826 is utilized to produce an image (i.e., a defoveated image including warp correction and/or other corrections) displayed using one or more external displays 830. As an example, the one or more external displays can be optically coupled to an eyepiece waveguide disposed in a head mounted display (HMD) and the one or more external displays 830 can display stereo video content. These correction processes can be performed simultaneously, concurrently, sequentially, or combinations thereof.

Thus, the spatial foveation performed by GPU 818 is reversed by warp reprojection processor 826 during the image warp process utilized to perform head pose correction and the like. As discussed in relation to spatial foveation map 700 illustrated in FIG. 7, multiple pixels at a greater distance from the eye gaze location are generated based on a single pixel during the spatial defoveation process, reducing resolution as a function of the distance from the eye gaze location. Since the same spatial foveation map (or the spatial foveation map and an inverse spatial defoveation map) can be utilized in both the foveation and the defoveation process, the image compression performed during spatial foveation can be reversed during spatial defoveation. After spatial foveation correction (i.e., spatial defoveation) by warp reprojection processor 826, the output image is once again N×M pixels, but with reduced spatial resolution at locations distant from the eye gaze location.

FIG. 8B is a schematic diagram illustrating a system for performing spatial foveation based on eye gaze according to an embodiment of the present invention. The schematic diagram shares common elements with the simplified computational flow diagram illustrated in FIG. 8A and the description provided in relation to FIG. 8A is applicable to FIG. 8B as appropriate.

Referring to FIG. 8B, the system 850 includes a remote computing device 860 and a local wearable device 870 that can be utilized to present virtual content to a user. Remote computing device 860 and local wearable device 870 can be elements of an augmented reality (AR) system. Eye tracking system 871 generates an eye gaze location that is provided to CPU 861, GPU 868, and warp reprojection processor 876. CPU 861 is utilized to generate virtual content represented by N×M input image 864 as well as spatial foveation map 866. The GPU 868 performs spatial foveation based on the eye gaze location provided by the eye tracking system 871 and the spatial foveation map 866. Communication system 869 is utilized to transmit the n×m spatially foveated image 872 produced by the spatial foveation process along with the spatial foveation map 866 from the remote computing device 860 to the local wearable device 870, which includes a communication device 875 in communication with communication system 869. In embodiments of the present invention, n<N and m<M; for example, the original image is an N=640×M=480 image and the spatially foveated image is an n=480×m=360 image. As a result, the number of pixels in the spatially foveated image 872 is less than the number of pixels in the N×M input image 814.

In addition to the CPU 861 and GPU 868, the eye gaze location generated by the eye tracking system 871 is provided to warp reprojection processor 876 of the local wearable device 870. The n×m spatially foveated image 872 is compressed non-uniformly, with reduced or no spatial compression in the vicinity of the eye gaze location and larger spatial compression for pixels at greater distances from the eye gaze location. This reduction in image size is beneficial in several ways, including reduced data transmission bandwidth, reduced processing load, and the like.

In order to provide an image for display to the user, the spatial foveation performed by the GPU 868 is reversed using a spatial defoveation process, also referred to as a spatial foveation correction process. In addition to spatial defoveation, other processes can be performed to generate an image suitable for display to a user. As an example, optical elements utilized in the display may be characterized by distortion. This distortion can be removed by performing a lens correction process. Moreover, since the user's head may have translated and/or rotated during the time between when the virtual content (e.g., the N×M input image) was generated and the time the image is displayed to the user through the one or more external displays 880, a head pose correction process can be performed.

Additionally, in embodiments utilizing eyepiece waveguide displays, the eyepiece waveguide may be characterized by a bend value, which can be corrected using a bend correction process as discussed above. Therefore, as illustrated in FIG. 8B, bend correction is one of the possible corrections that can be performed by the warp reprojection processor 876 (e.g., the late stage reprojection processor) in addition to other corrections that can be performed (e.g., lens, foveation, color, or the like).

Using the eye gaze location, the n x m spatially foveated image 872, correction inputs 874, which can include lens correction, head pose correction, bend correction, spatial foveation correction, and the like, and spatial foveation map 866, warp reprojection processor 876 is utilized to produce an image displayed using one or more external displays 880. As an example, the one or more external displays can be optically coupled to an eyepiece waveguide disposed in a head mounted display (HMD) and the one or more external displays 880 can display stereo video content. These correction processes can be performed simultaneously, concurrently, sequentially, or combinations thereof.

Thus, the spatial foveation performed by GPU 868 is reversed by warp reprojection processor 876 during the image warp process utilized to perform head pose correction and the like. After spatial foveation correction (i.e., spatial defoveation) by warp reprojection processor 876, the output image is once again N×M pixels, but with reduced spatial resolution at locations distant from the eye gaze location. One of ordinary skill in the art would recognize many variations, modifications, and alternatives.

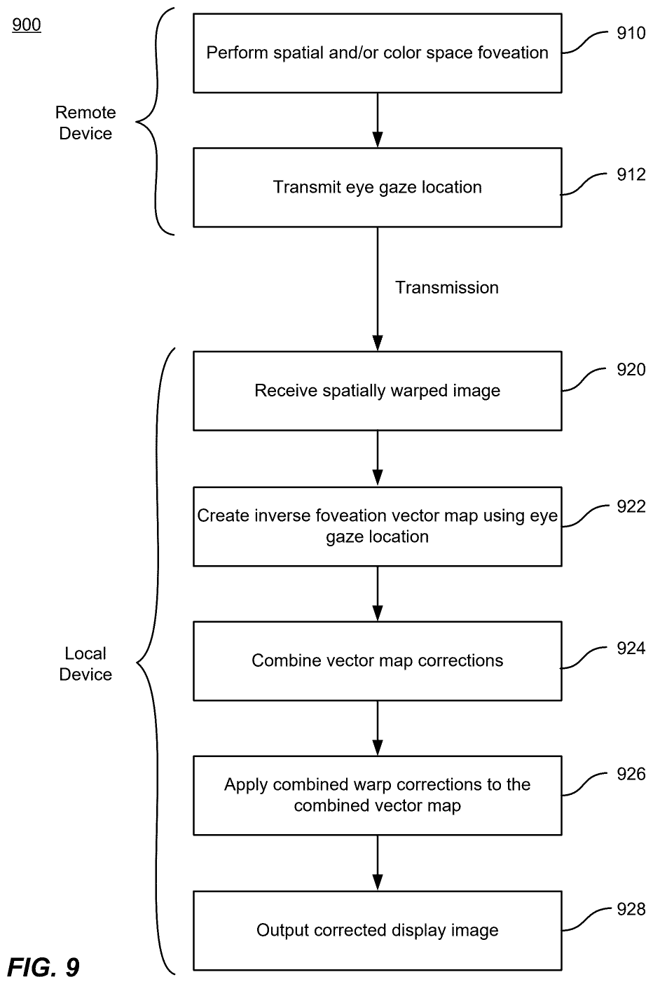

FIG. 9 is a simplified flowchart illustrating a method of performing spatial foveation based on eye gaze location according to an embodiment of the present invention. The method 900 includes performing, on a remote device, spatial and/or color space foveation based on the eye gaze location (910). The remote device can be a component of the AR system or a remote server (e.g., a cloud server). The spatial foveation is performed using a spatial foveation map. In addition to spatial foveation, initial warp based on expected head pose can be performed in conjunction with the spatial foveation. The eye gaze location is transmitted to the local device (912).

At the local device, the method includes receiving a spatially warped image (920) and creating an inverse foveation vector map based on the eye gaze location (922). In some embodiments, the inverse foveation vector map, also referred to as an inverse spatial foveation map or a spatial defoveation map, can be created at the remote device and transmitted to the local device. The method also includes combining a plurality of vector map corrections, including, but not limited to, warp, lens, bend, and/or spatial foveation corrections (924). Using the combined vector map, the combined correction is applied (926) to form and output the corrected display image (928).

It should be appreciated that the specific steps illustrated in FIG. 9 provide a particular method of performing spatial foveation based on eye gaze location according to an embodiment of the present invention. Other sequences of steps may also be performed according to alternative embodiments. For example, alternative embodiments of the present invention may perform the steps outlined above in a different order. Moreover, the individual steps illustrated in FIG. 9 may include multiple sub-steps that may be performed in various sequences as appropriate to the individual step. Furthermore, additional steps may be added or removed depending on the particular applications. One of ordinary skill in the art would recognize many variations, modifications, and alternatives.

FIG. 10A is an original image prior to spatial foveation. The image illustrated in FIG. 10A is an N×M image, for example, a virtual image that can be displayed using the AR system described herein.

FIG. 10B is a spatially foveated image according to an embodiment of the present invention. Given the N×M input image illustrated in FIG. 10A, the spatial foveation process described herein is utilized to spatially foveate the N×M input image and produce the n×m image illustrated in FIG. 10B. For the spatial foveation process illustrated in FIG. 10B, the eye gaze location is the center of the image. As shown in FIG. 10B, portions of the image farthest from the eye gaze location experience the greatest foveation, resulting in removal of pixels at the corners and sides of the image. Because of the reduced pixel count associated with the spatially foveated image illustrated in FIG. 10B, memory and processing requirements are reduced by embodiments of the present invention. It should be noted that the foveated image may not be rectangular since the number of pixels combined during the spatial foveation process increases with distance from the eye gaze location. Accordingly, the foveated image illustrated in FIG. 10B has a smaller number of pixels in the first and last rows than in the center of the image. One of ordinary skill in the art would recognize many variations, modifications, and alternatives. Thus, the reference to the spatially foveated image as an n×m image does not require the spatially foveated image to be rectangular.

FIG. 10C is a restored image according to an embodiment of the present invention. Given the spatially foveated image illustrated in FIG. 10B and the spatial defoveation map, for example, spatial foveation map 700 illustrated in FIG. 7, warp reprojection processor 826 illustrated in FIG. 8A/warp reprojection processor 876 illustrated in FIG. 8B is utilized to restore the spatially foveated image (i.e., the n×m image illustrated in FIG. 10B) to the original N×M image size. The spatial defoveation map can be generated by warp reprojection processor 826 illustrated in FIG. 8A/warp reprojection processor 876 illustrated in FIG. 8B based on the spatial foveation map 816/spatial foveation map 866 or may be provided to warp reprojection processor 826 illustrated in FIG. 8A/warp reprojection processor 876 illustrated in FIG. 8B. Thus, in some embodiments, rather than sending the spatial foveation map to the local computing device, the spatial defoveation map is generated at the remote computing device and transmitted to the local computing device. One of ordinary skill in the art would recognize many variations, modifications, and alternatives. As illustrated in FIG. 10C, although resolution is reduced at the corners and sides of the image in comparison to the N×M input image, these changes make a limited impact on the user experience since the reduced resolution regions are in the user's peripheral vision.

Although in the example illustrated in FIGS. 10A-10C, the warp reprojection processor was utilized to expand the n×m foveated image illustrated in FIG. 10B back to the original N×M image size illustrated in FIGS. 10A and 10C, embodiments of the present invention are not limited to expanding the foveated image back to the original size. In some cases, the warp reprojection processor can be utilized to expand the restored image to a size larger than the original size, i.e., N′×M′, wherein N′>N and M′>M. For instance, this expansion to a restored image size larger than the original image size can be implemented for display of the restored image on a larger external display while maintaining the bandwidth corresponding to the original image. Thus, embodiments of the present invention can implement a “zoom” function by using the warp reprojection processor to apply the expansion in image size in addition to the other compensations discussed herein. One of ordinary skill in the art would recognize many variations, modifications, and alternatives.

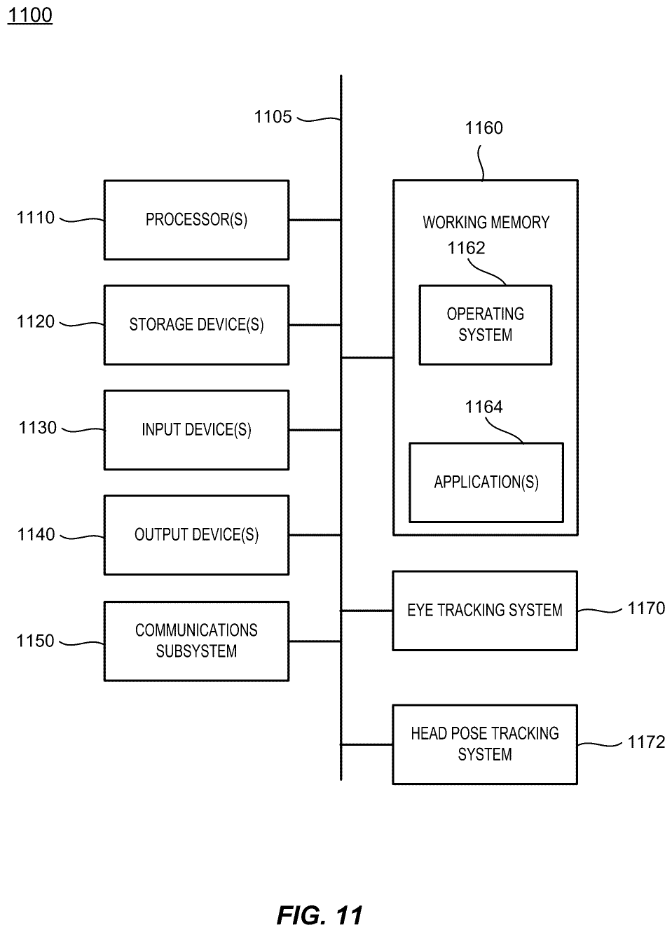

FIG. 11 is a simplified block diagram illustrating components of an AR system according to an embodiment of the present invention. AR system 1100 as illustrated in FIG. 11 may be incorporated into the AR devices as described herein. FIG. 11 provides a schematic illustration of one embodiment of AR system 1100 that can perform some or all of the steps of the methods provided by various embodiments. It should be noted that FIG. 11 is meant only to provide a generalized illustration of various components, any or all of which may be utilized as appropriate. FIG. 11, therefore, broadly illustrates how individual system elements may be implemented in a relatively separated or relatively more integrated manner.

AR system 1100 is shown comprising hardware elements that can be electrically coupled via a bus 1105, or may otherwise be in communication, as appropriate. The hardware elements may include one or more processors 1110, including without limitation one or more general-purpose processors and/or one or more special-purpose processors such as digital signal processing chips, graphics acceleration processors, and/or the like; one or more input devices 1130, which can include without limitation a mouse, a keyboard, a camera, and/or the like; and one or more output devices 1140, which can include without limitation a display device, a printer, and/or the like. Additionally, AR system 1100 includes an eye tracking system 1170 that can provide the user's eye gaze location to the AR system. Utilizing one or more processors 1110, the foveated image compression techniques discussed herein can be implemented. In order to provide the user's head pose, AR system 1100 includes a head pose tracking system 1172 that provides the head pose corresponding to the position and orientation of the wearable device to the AR system. As illustrated in FIG. 8B, head pose tracking system 873 corresponds to head pose tracking system 1172 and provides the head pose to warp reprojection processor 876.

AR system 1100 may further include and/or be in communication with storage device(s) 1120 (e.g., one or more non-transitory storage devices), which can comprise, without limitation, local and/or network accessible storage, and/or can include, without limitation, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

AR system 1100 might also include a communications subsystem 1150, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. Communications subsystem 1150 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via communications subsystem 1150. In other embodiments, a portable electronic device, e.g., the first electronic device, may be incorporated into AR system 1100, e.g., an electronic device as an input device 1130. In some embodiments, AR system 1100 will further comprise a working memory 1160, which can include a RAM or ROM device, as described above.

AR system 1100 also can include software elements, shown as being currently located within working memory 1160, including an operating system 1162, device drivers, executable libraries, and/or other code, such as one or more application programs 1164, which may comprise computer programs provided by various embodiments, and/or may be designed to implement methods, and/or configure systems, provided by other embodiments, as described herein. Merely by way of example, one or more procedures described with respect to the methods discussed above might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as storage device(s) 1120 described above. In some cases, the storage medium might be incorporated within a computer system, such as AR system 1100. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by AR system 1100 and/or might take the form of source and/or installable code, which, upon compilation and/or installation on AR system 1100, e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as AR system 1100 to perform methods in accordance with various embodiments of the technology. According to a set of embodiments, some or all of the procedures of such methods are performed by AR system 1100 in response to one or more processors 1110 executing one or more sequences of one or more instructions, which might be incorporated into operating system 1162 and/or other code, such as an application program 1164, contained in working memory 1160. Such instructions may be read into working memory 1160 from another computer-readable medium, such as one or more of storage device(s) 1120. Merely by way of example, execution of the sequences of instructions contained in working memory 1160 might cause one or more processors 1110 to perform one or more procedures of the methods described herein. Additionally or alternatively, portions of the methods described herein may be executed through specialized hardware.

The terms machine-readable medium and computer-readable medium, as used herein, refer to any medium that participates in providing data that causes a machine to operate in a specific fashion. In an embodiment implemented using AR system 1100, various computer-readable media might be involved in providing instructions/code to one or more processors 1110 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as storage device(s) 1120. Volatile media include, without limitation, dynamic memory, such as working memory 1160.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to one or more processors 1110 for execution. Merely by way of example, the instructions may initially be carried on a magnetic disk and/or optical disc of a remote computer. A remote computer might load the instructions into its dynamic memory and send the instructions as signals over a transmission medium to be received and/or executed by AR system 1100.

Communications subsystem 1150 and/or components thereof generally will receive signals, and bus 1105 then might carry the signals and/or the data, instructions, etc. carried by the signals to working memory 1160, from which one or more processors 1110 retrieves and executes the instructions. The instructions received by working memory 1160 may optionally be stored on storage device(s) 1120, e.g., a non-transitory storage device, either before or after execution by one or more processors 1110.

Various examples of the present disclosure are provided below. As used below, any reference to a series of examples is to be understood as a reference to each of those examples disjunctively (e.g., “Examples 1-4” is to be understood as “Examples 1, 2, 3, or 4”).

Example 1 is a method comprising: determining an eye gaze location of a user; generating a spatial foveation map based on the eye gaze location; receiving an image; forming a spatially foveated image using the image and the spatial foveation map; transmitting the spatially foveated image to a wearable device; spatially defoveating the spatially foveated image to produce a spatially defoveated image; and displaying the spatially defoveated image.

Example 2 is the method of example 1 further comprising performing image warp correction based on head pose of the wearable device in conjunction with defoveating the spatially foveated image to produce the spatially defoveated image.

Example 3 is the method of example(s) 1-2 wherein spatially defoveating the spatially foveated image comprises performing image warp based on head pose of the wearable device.

Example 4 is the method of example(s) 1-3 wherein determining the eye gaze location comprises use of an eye tracking camera of an augmented reality device.

Example 5 is the method of example(s) 1-4 wherein the spatial foveation map includes vectors of different magnitude as a function of distance from the eye gaze location.

Example 6 is the method of example(s) 1-5 wherein the spatial foveation map includes a central region and a peripheral region.

Example 7 is the method of example(s) 1-6 wherein the image comprises virtual content generated by an augmented reality device.

Example 8 is the method of example(s) 1-7 wherein the wearable device includes one or more displays.

Example 9 is the method of example(s) 1-8 wherein forming the spatially foveated image is performed at a remote computing device, wherein the wearable device and the remote computing device are components of an augmented reality system.

Example 10 is the method of example(s) 1-9 wherein forming the spatially foveated image is performed by a cloud server.

Example 11 is the method of example(s) 1-10 further comprising generating an inverse spatial foveation map prior to spatially defoveating the spatially foveated image.

Example 12 is the method of example 11 wherein the inverse spatial foveation map includes at least one of image warp correction based on head pose of the wearable device, lens correction, or bend correction.

Example 13 is a method comprising: determining an eye gaze location of a user; generating, at a remote computing device, a spatial foveation map based on the eye gaze location; receiving an image; forming a spatially foveated image using the image and the spatial foveation map; transmitting the spatially foveated image to a wearable computing device; receiving, at the wearable computing device, a head pose correction for the wearable computing device; warping and spatially defoveating the spatially foveated image to produce a display image; and displaying, at the wearable computing device, the display image.

Example 14 is the method of example 13 wherein warping and spatially defoveating the spatially foveated image comprises: spatially defoveating the spatially foveated image to form a defoveated image; and warping the defoveated image.

Example 15 is the method of example(s) 13-14 wherein warping and spatially defoveating the spatially foveated image comprises: warping the spatially foveated image to form a warped image; and spatially defoveating the warped image.

Example 16 is the method of example(s) 13-15 wherein determining the eye gaze location comprises use of an eye tracking camera of an augmented reality device.

Example 17 is the method of example(s) 13-16 wherein the spatial foveation map includes vectors of different magnitude as a function of distance from the eye gaze location.

Example 18 is the method of example(s) 13-17 wherein the spatial foveation map includes a central region and a peripheral region.

Example 19 is the method of example(s) 13-18 wherein the image comprises virtual content generated by an augmented reality device.

Example 20 is the method of example(s) 13-19 wherein the wearable computing device includes one or more displays.

Example 21 is the method of example(s) 13-20 wherein forming the spatially foveated image is performed at a remote computing device, wherein the wearable computing device and the remote computing device are components of an augmented reality system.

Example 22 is the method of example(s) 13-21 wherein forming the spatially foveated image is performed by a cloud server.

Example 23 is the method of example(s) 13-22 further comprising generating an inverse spatial foveation map prior to warping and spatially defoveating the spatially foveated image.

Example 24 is the method of example(s) 13-23 wherein warping and spatially defoveating the spatially foveated image further comprises performing lens correction or bend correction.

Example 25 is an augmented reality (AR) system comprising: a remote computing device including: a processor; a memory; and a communication system coupled to the processor; and a wearable device including: a frame; a communication device coupled to the frame; a projector coupled to the frame; a display optically coupled to the projector; an eye tracking system; and a reprojection processor coupled to the frame.

Example 26 is the AR system of example 25 wherein the processor comprises a central processing unit and a graphics processing unit.

Example 27 is the AR system of example(s) 25-26 wherein the processor is configured to generate an image, a spatial foveation map based on an eye gaze location, and a spatially foveated image.

Example 28 is the AR system of example(s) 25-27 wherein the image comprises virtual content generated by the processor.

Example 29 is the AR system of example(s) 25-27 wherein the communication device is configured to receive the image and the spatial foveation map.

Example 30 is the AR system of example(s) 27-29 wherein the reprojection processor is configured to: receive the spatially foveated image and the spatial foveation map; generate a spatial defoveation map based on the eye gaze location or the spatial foveation map; and generate a spatially defoveated image based on the spatially foveated image and the spatial defoveation map.

Example 31 is the AR system of example(s) 27-30 wherein the spatial foveation map includes vectors of different magnitude as a function of distance from the eye gaze location.

Example 32 is the AR system of example(s) 27-31 wherein the spatial foveation map includes a central region and a peripheral region.

Example 33 is the AR system of example(s) 25-32 further comprising a head pose tracking system.

Example 34 is the AR system of example 33 wherein the reprojection processor is further configured to perform image warp based on head pose of the wearable device.

Example 35 is the AR system of example(s) 25-34 wherein the remote computing device comprises a cloud server.

Example 36 is an augmented reality (AR) system comprising: a wearable device including: a frame; one or more image capture devices coupled to the frame; a set of projectors coupled to the frame; a set of displays coupled to the frame, wherein each of the set of displays is optically coupled to one of the set of projectors; and a set of eye tracking devices coupled to the frame; a memory; and a processor coupled to the memory, wherein the processor is configured to: determine an eye gaze location of a user; generate a spatial foveation map based on the eye gaze location; receive an image; form a spatially foveated image using the image and the spatial foveation map; transmit the spatially foveated image to a wearable device; spatially defoveate the spatially foveated image to produce a spatially defoveated image; and display the spatially defoveated image.

Example 37 is the AR device of example 36 wherein the processor is further configured to perform image warp correction based on head pose of the wearable device in conjunction with spatially defoveating the spatially foveated image.

Example 38 is the AR device of example(s) 36-37 wherein the processor is further configured to perform lens correction or bend correction in conjunction with spatially defoveating the spatially foveated image.

Example 39 is the AR device of example(s) 36-38 wherein the set of eye tracking devices comprises a plurality of eye tracking cameras.

Example 40 is the AR device of example(s) 36-39 wherein the processor is further configured to generate virtual content.

Example 41 is the AR device of example(s) 36-40 wherein the processor is further configured to generate an inverse spatial foveation map prior to spatially defoveating the spatially foveated image.

Example 42 is a non-transitory computer-readable medium comprising program code that is executable by a processor of a device that is wearable by a user, the program code being executable by the processor to: determine an eye gaze location of a user; generate a spatial foveation map based on the eye gaze location; receive an image; form a spatially foveated image using the image and the spatial foveation map; transmit the spatially foveated image to a wearable device; spatially defoveate the spatially foveated image to produce a spatially defoveated image; and display the spatially defoveated image.

Example 43 is the non-transitory computer-readable medium of example 42 further comprising program code executable by the processor to perform image warp correction based on head pose of the device in conjunction with spatially defoveating the spatially foveated image to produce the spatially defoveated image.

Example 44 is the non-transitory computer-readable medium of example(s) 42-43 further comprising program code executable by the processor to perform lens correction or bend correction in conjunction with spatially defoveating the spatially foveated image.

Example 45 is the non-transitory computer-readable medium of example(s) 42-44 further comprising program code executable by the processor to generate virtual content.

Example 46 is the non-transitory computer-readable medium of example(s) 42-45 wherein the spatial foveation map includes vectors of different magnitude as a function of distance from the eye gaze location.

Example 47 is the non-transitory computer-readable medium of example(s) 42-46 wherein the spatial foveation map includes a central region and a peripheral region.

Example 48 is the non-transitory computer-readable medium of example(s) 42-47 wherein the processor is further configured to generate an inverse spatial foveation map prior to spatially defoveating the spatially foveated image.

In the foregoing specification, the disclosure has been described with reference to specific embodiments thereof. It will, however, be evident that various modifications and changes may be made thereto without departing from the broader spirit and scope of the disclosure. The specification and drawings are, accordingly, to be regarded in an illustrative rather than restrictive sense.

Indeed, it will be appreciated that the systems and methods of the disclosure each have several innovative aspects, no single one of which is solely responsible or required for the desirable attributes disclosed herein. The various features and processes described above may be used independently of one another, or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Accordingly, the claims are not intended to be limited to the embodiments shown herein but are to be accorded the widest scope consistent with this disclosure, the principles, and the novel features disclosed herein. Thus, it is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method comprising:
determining an eye gaze location of a user;
generating a spatial foveation map based on the eye gaze location;
receiving an image;
forming a spatially foveated image using the image and the spatial foveation map;
transmitting the spatially foveated image to a wearable device;
spatially defoveating the spatially foveated image to produce a spatially defoveated image; and
displaying the spatially defoveated image.

2. The method of claim 1 further comprising performing image warp correction based on head pose of the wearable device in conjunction with defoveating the spatially foveated image to produce the spatially defoveated image.

3. The method of claim 1 wherein spatially defoveating the spatially foveated image comprises performing image warp based on head pose of the wearable device.

4. The method of claim 1 wherein determining the eye gaze location comprises use of an eye tracking camera of an augmented reality device.

5. The method of claim 1 wherein the spatial foveation map includes vectors of different magnitude as a function of distance from the eye gaze location.

6. The method of claim 1 wherein the spatial foveation map includes a central region and a peripheral region.

7. The method of claim 1 wherein the image comprises virtual content generated by an augmented reality device.

8. The method of claim 1 wherein the wearable device includes one or more displays.

9. The method of claim 1 wherein forming the spatially foveated image is performed at a remote computing device, wherein the wearable device and the remote computing device are components of an augmented reality system.

10. The method of claim 1 wherein forming the spatially foveated image is performed by a cloud server.

11. The method of claim 1 further comprising generating an inverse spatial foveation map prior to spatially defoveating the spatially foveated image.

12. The method of claim 11 wherein the inverse spatial foveation map includes at least one of image warp correction based on head pose of the wearable device, lens correction, or bend correction.

13. An augmented reality (AR) system comprising:
a wearable device including:
a frame;
one or more image capture devices coupled to the frame;
a set of projectors coupled to the frame;
a set of displays coupled to the frame, wherein each of the set of displays is optically coupled to one of the set of projectors; and
a set of eye tracking devices coupled to the frame;
a memory; and
a processor coupled to the memory, wherein the processor is configured to:
determine an eye gaze location of a user;
generate a spatial foveation map based on the eye gaze location;
receive an image;
form a spatially foveated image using the image and the spatial foveation map;
transmit the spatially foveated image to a wearable device;
spatially defoveate the spatially foveated image to produce a spatially defoveated image; and
display the spatially defoveated image.

14. The AR device of claim 13 wherein the processor is further configured to perform image warp correction based on head pose of the wearable device in conjunction with spatially defoveating the spatially foveated image.

15. The AR device of claim 14 wherein the processor is further configured to perform lens correction or bend correction in conjunction with spatially defoveating the spatially foveated image.

16. The AR device of claim 13 wherein the set of eye tracking devices comprises a plurality of eye tracking cameras.

17. The AR device of claim 13 wherein the processor is further configured to generate virtual content.

18. The AR device of claim 13 wherein the processor is further configured to generate an inverse spatial foveation map prior to spatially defoveating the spatially foveated image.

19. The AR device of claim 13 wherein the spatial foveation map includes vectors of different magnitude as a function of distance from the eye gaze location.

20. The AR device of claim 13 wherein the spatial foveation map includes a central region and a peripheral region.
